(19) United States
(12) Patent Application Publication
(10) Pub. No.: US 2014/0258476 A1
(43) Pub. Date: Sep. 11, 2014

(54) FILE TRANSMISSION TO COMMUNICATION-DISABLED TERMINAL

(71) Applicant: SK TELECOM CO., LTD., Seoul (KR)

(72) Inventor: Woo Yong CHOI, Anyang-si (KR)

(73) Assignee: SK TELECOM CO., LTD., Seoul (KR)

(21) Appl. No.: 14/286,465

(22) Filed: May 23, 2014

Related U.S. Application Data
(63) Continuation of application No. PCT/KR2012/010117, filed on Nov. 27, 2012.

(30) Foreign Application Priority Data
Nov. 29, 2012 (KR) 10-2011-0126343

(51) Int. Cl. H04L 29/08

(52) U.S. Cl. CPC H04L 67/06
USPC 709/219

(57) ABSTRACT

An apparatus for transmitting a file to a terminal device in a communication-disabled state includes a transceiver unit includes: a transceiver unit to transmit and receive data; a storage unit to store therein file information on a file uploaded to a content server by a transmitting terminal device using a first protocol; and a control unit to receive the file information from the transmitting terminal device through the transceiver unit using a second protocol, deliver the received file information to a receiving terminal device using the second protocol, store the file information in the storage unit when a predetermined time elapses without a response from the receiving terminal device, and transmit the stored file information to the receiving terminal device through the transceiver unit when the receiving terminal device enters into a communication-enabled state.

### CROSS-REFERENCE TO RELATED APPLICATIONS

The instant application is a continuation of PCT/KR2012/00117, filed Nov. 27, 2012, which is based on and claims priority to Korean Patent Application No. 10-2011-0126343, filed on Nov. 29, 2011. The disclosures of above-listed applications are hereby incorporated by reference herein in their entirety.

### TECHNICAL FIELD

The present disclosure relates to file transmission technology and, more particularly, to an apparatus and a recording medium for transmitting a file to a terminal in a communication-disabled state.

### BACKGROUND

The statements in this section merely provide background information related to the present disclosure and do not constitute prior art.

While a variety of message services such as a short message service (SMS), a multimedia messaging service (MMS), and so on have been widely used, recently, an instant messaging (IM) service is actively being used.

Advantageously, the IM service can provide a function of sending and receiving messages in almost real time, as compared to an electronic mail, in addition to an existing function of transmitting texts and multimedia data.

A session initiation protocol (SIP) is widely used as a type of a signaling protocol for such instant messaging. The SIP is an application layer protocol used to establish, modify, and terminate multimedia sessions such as a voice over Internet protocol (VoIP).

A message session relay protocol (MSRP) is used as a protocol for transmitting and receiving data, in which data to be transmitted from a transmitting terminal device (hereinafter, referred to as “transmitting terminal”) to a receiving terminal device (hereinafter, referred to as “receiving terminal”) is divided into several chunks and transmitted using an MSRP session.

However, the inventor(s) has noted that in order to use the MSRP session to transmit a specific file or the like, a call processing should be previously performed using an SIP INVITE message, and so forth, and data packets relay all hops when a file is transferred using the MSRP, thereby inefficiently occupying network resources.

In addition, the inventor(s) has noted that it is impossible to transmit the file using the MSRP session when the receiving terminal is in a communication-disabled state such as in an offline state or in a dead zone, and it is burdensome to check whether the corresponding receiving terminal becomes able to be in a communication-enabled state and to establish the session again and attempt to transmit the file by means of the transmitting terminal.

In particular, the inventor(s) has experienced that in a context of increasing a network load due to explosive increase in IM services, an unconditional data transmission attempt using a chatting session is a main reason causing a network state to be deteriorated.

### SUMMARY

The present disclosure is directed to file transmission technique. Embodiments of this disclosure relate to an apparatus and a recording medium for transmitting a file to a terminal incapable of communication, allowing the file to be stored in a content server when the terminal is in a communication-disabled state such as being in an offline state or located in a dead zone. When the terminal enters into a communication-enabled state, the terminal receives the file from the content server. This technique realizes convenient transmission of files regardless of a communication state of the terminal.

In accordance with some embodiments, an apparatus for transmitting a file to a terminal device in a communication-disabled state includes a transceiver unit, a storage unit, and a control unit. The transceiver unit is configured to transmit and receive data. The storage unit is configured to store therein file information on a file uploaded to a content server by a transmitting terminal device using a first protocol. And the control unit is configured to receive the file information from the transmitting terminal device through the transceiver unit using a second protocol, deliver the received file information to a receiving terminal device using the second protocol, store the file information in the storage unit when a predetermined time elapses without a response from the receiving terminal device, and transmit the stored file information to the receiving terminal device through the transceiver unit when the receiving terminal device enters into a communication-enabled state.

In accordance with some embodiments, an apparatus for transmitting a file to a terminal device in a communication-disabled state includes a transceiver unit, a storage unit, and a control unit. The transceiver unit is configured to transmit and receive data. The storage unit is configured to store therein file information on a file uploaded to a content server by a transmitting terminal device. And the control unit is configured to store the received file information in the storage unit when receiving the file information using a message session relay protocol (MSRP) SEND method from the transmitting terminal device through the transceiver unit after a predetermined time elapses without a response from a receiving terminal device even though session establishment is attempted between the transmitting terminal device and the receiving terminal device, and transmit the stored file information to the receiving terminal device through the transceiver unit when the receiving terminal device enters into a communication-enabled state.

In accordance with some embodiments, a non-transitory computer readable recording medium containing a program, the program, when executed by a message server, causing the message server to execute: receiving, from a transmitting terminal device, file information on a file uploaded to a content server, wherein the file is uploaded by the transmitting terminal device using a first protocol; attempting to contact a receiving terminal device using a second protocol; determining that the receiving terminal device is in a communication-disabled state and storing the file information; and transmitting the stored file information to the receiving terminal device when the receiving terminal device enters into a communication-enabled state back from the communication-disable state such that the receiving terminal device downloads the uploaded file through the first protocol from the content server by using the file information.

### BRIEF DESCRIPTION OF DRAWINGS

FIG. 1 is a diagram of a configuration of a file transfer system to a communication-disabled terminal according to at least one exemplary embodiment of the present disclosure.

FIG. 2 is a diagram of a configuration of a message server according to the at least one exemplary embodiment of FIG. 1.

FIG. 3 is a diagram of a configuration of a content server according to the at least one exemplary embodiment of FIG. 1.

FIG. 4 is a diagram of a configuration of a transmitting terminal according to the at least one exemplary embodiment of FIG. 1.

FIG. 5 is a diagram of a configuration of a receiving terminal according to the at least one exemplary embodiment of FIG. 1.

FIG. 6 is a flowchart of a method of transmitting files to a communication-disabled terminal according to at least one exemplary embodiment of the present disclosure.

FIG. 7 is a flowchart of a method of transmitting files to a communication-disabled terminal according to at least another exemplary embodiment of the present disclosure.

### DETAILED DESCRIPTION

Hereinafter, preferred embodiments of the present disclosure will be described in detail with reference to the accompanying drawings such that a person skilled in the art easily carries out the embodiments of the present disclosure. Moreover, detailed descriptions related to well-known functions or configurations will be ruled out in order not to unnecessarily obscure subject matters of the present disclosure. In addition, like reference numerals refer to like elements throughout the specification. Various embodiments of the present disclosure relate to an apparatus and a recording medium for transmitting a file to a terminal incapable of communication (i.e., a terminal in communication-disable or inactive state), which allow the file to be stored in a content server and, when the terminal enters into a communication-enabled state, allow the terminal to receive the stored file from the content server.

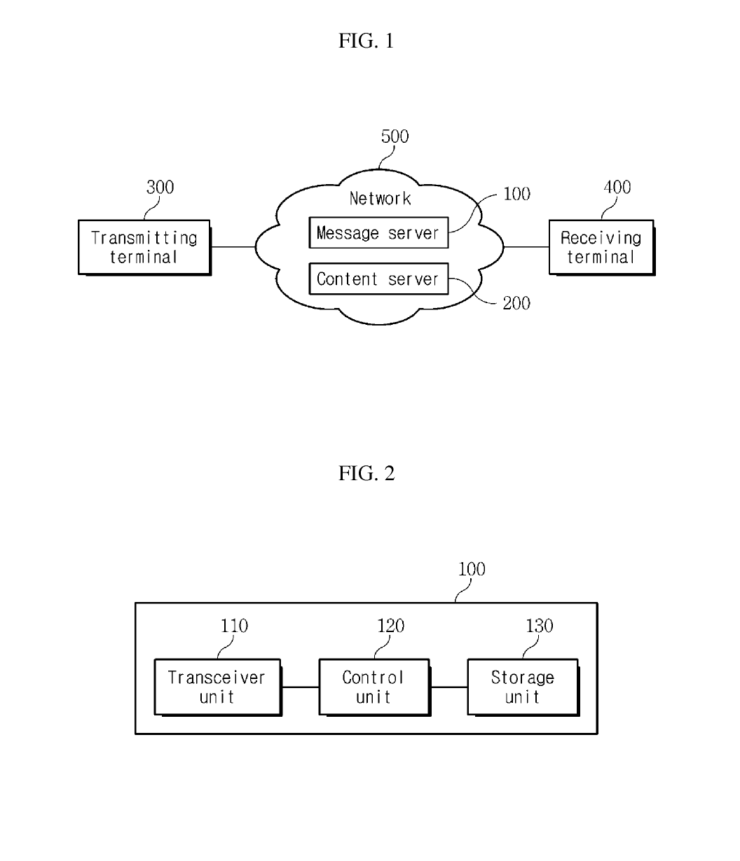

FIG. 1 is a diagram of a configuration of a file transfer system to a communication-disabled terminal according to at least one exemplary embodiment of the present disclosure.

Referring to FIG. 1, the file transfer system of the present disclosure includes a message server 100, a content server 200, a transmitting terminal 300, a receiving terminal 400, and a network 500. All or some components of the file transfer system, such as the message server 100, the content server 200, the transmitting terminal 300, and the receiving terminal 400 are implemented by one or more processors and/or application-specific integrated circuits (ASICs).

The network 500 is a communication network for transmitting and receiving data to exchange information among the transmitting terminal 300, the receiving terminal 400, the content server 200, and the message server 100.

The network 500 is interpreted as a concept including an Internet multimedia subsystem (IMS) infrastructure for providing an IP-based multimedia application service and also including a variety of wired and wireless networks that have been developed and commercialized or will be developed, depending on a type of the transmitting terminal 300 or the receiving terminal 400.

The network 500 includes a device such as a call state control function (CSCF) for performing session exchange and call control.

Each of the transmitting terminal 300 and the receiving terminal 400 is a terminal device capable of supporting a chatting function to a user, which is one of a variety of wired and wireless terminals such as a mobile phone, a smartphone, a home appliance, a computer, and a notebook.

The transmitting terminal 300 includes a communication interface for transmitting a chatting message or data to the receiving terminal 400 or uploading a file to the message server 100, an input device for inputting the chatting message, and a display device for displaying the received chatting message.

The message server 100 is one of one re more entities composing of the network 500, and a kind of a chatting server that provides an instant messaging (IM) service between the transmitting terminal 300 and the receiving terminal 400.

The message server 100 identifies subscribed users with user identifiers, manages a state, a reception mode, a message receiver list, and subscriber environment information for each subscribed user, and manages an IM conversation session for delivering IM conversation messages among users who are on-line to the Internet.

The message server 100 performs session initiation protocol (SIP) call processing, message session relay protocol (MSRP) relay, and so on, which allows a chatting service to be provided between the transmitting terminal 300 and the receiving terminal 400.

In at least one embodiment of the present disclosure, the transmitting terminal 300 uploads one or more files, which have already been store therein, to the content server 200 using an hypertext transfer protocol (HTTP) POST message. In this case, the POST is an HTTP method used for a client to send any data to a server.

When receiving a file from the transmitting terminal 300, the content server 200 stores the received file therein and transmits file information on the stored file to the transmitting terminal 300. In this case, the file information includes at least one of file link information, a file class ID, and a file size.

When the content server 200 stores the received files, the content server stores the file in its internal storage or stores the file in a separate external server capable of communicating with the network 500.

In this case, the content server 200 transmits the file information on the file to the transmitting terminal 300 using an HTTP 200 OK response message. For example, the content server 200 transmits the HTTP 200 OK message including the file information such as file link information, file class ID, file size, or the like to the transmitting terminal 300.

In addition, the file link information transmitted by the content server 200 to the transmitting terminal 300 includes, for example, information such as a uniform resource locator (URL) or uniform resource indicator (URI) on where the file is stored.

When receiving the file information from the content server 200, the transmitting terminal 300 transmits the file information to the message server 100, and the message server 100 then transfers the file information to the receiving terminal 400.

In this case, the transmitting terminal 300 or the message server 100 transmits the file information using an SIP MESSAGE method.

When a predetermined time elapses without a response from the receiving terminal 400 due to that the receiving terminal 400 is in an offline state or in a dead zone after the message server 100 transmits the file information to the receiving terminal 400 using the SIP MESSAGE method, the message server 100 stores the file information on the corresponding file in its internal or separate storage, and transmits a 202 ACCEPTED message (response message) to the transmitting terminal 300.

In this case, the message server 100 confirms that there is no response from the receiving terminal 400 at the time of expiration of an internal timer or by receiving an SIP 480 temporarily-unavailable response indicating that a timer is expired from a separate device.

Afterwards, when the receiving terminal 400 becomes in a communication-enabled state such as in an online state, the message server 100 receives an SIP REGISTER message for registration from the receiving terminal 400, and the message server 100 transmits the file information to the receiving terminal 400 using the SIP MESSAGE method.

When receiving the file information from the message server 100, the receiving terminal 400 uses the file information to request the file from the content server 200 and download the file.

In this case, the receiving terminal 400 transmits an HTTP GET message to the content server 200, receive a 200 OK message in response to the transmission, and then download the file. Here, the GET is an HTTP method used to request that the server retrieve a resource designated by a URL or the like included in an HTTP request line and to transmit the found resource to a client.

In at least another embodiment of the present disclosure, an SIP INVITE message for establishing a session between the transmitting terminal 300 and the receiving terminal 400 is transmitted from the transmitting terminal 300 to the message server 100, and the message server 100 transmits the INVITE message to the receiving terminal 400.

When a predetermined time elapses without a response from the receiving terminal 400 due to that the receiving terminal 400 is in an offline state or in a dead zone after the message server 100 transmits the INVITE message to the receiving terminal 400, the message server 100 transmits a 200 OK message as a response to the transmitting terminal 300.

In this case, the message server 100 confirms that there is no response from the receiving terminal 400 at the time of expiration of an internal timer or by receiving an SIP 480 temporarily-unavailable response indicating that a timer is expired from a separate device.

The transmitting terminal 300 then uploads the internal file to the content server 200 using the HTTP POST message.

The content server 200 that has received the file from the transmitting terminal 300 stores the file, and transmits file information on the stored file to the transmitting terminal 300. In this case, the file information includes at least one of file link information, a file class ID, and a file size.

When the content server 200 stores the received file, the content server stores the file in its internal storage or stores the file in a separate external server capable of communicating with the network 500.

In this case, the content server 200 transmits the corresponding file information to the transmitting terminal 300 using an HTTP 200 OK response message. For example, the content server 200 transmits the HTTP 200 OK message including file information such as file link information, file class ID, file size, or the like to the transmitting terminal 300.

In addition, the file link information transmitted by the content server 200 to the transmitting terminal 300 includes, for example, information such as URL or URI on where the file is stored.

The transmitting terminal 300 then transmits the file information to the message server 100 using an MSRP SEND method, and the message server 100 store the information on the corresponding file in its internal storage or a separate storage and transmits a 200 OK message as a response to the transmitting terminal 300.

Afterwards, when the receiving terminal 400 becomes in a communication-enabled state such as in an online state, the message server 100 receives an SIP REGISTER message for registration from the receiving terminal 400, and the message server 100 transmits the file information to the receiving terminal 400 using an SIP MESSAGE method.

The receiving terminal 400 that has received the file information from the message server 100 uses the file information to request the corresponding file from the content server 200 and download the file.

In this case, the receiving terminal 400 transmits an HTTP GET message to the content server 200, and receive a 200 OK message as a response and download the corresponding file.

In this file transfer process, a file is not directly transmitted between the transmitting terminal 300 and the receiving terminal 400, but a file is downloaded using the content server 200 when the receiving terminal 400 in the communication-disabled state comes back into a communication-enabled state.

Functions and operations of the message server 100 according to the present disclosure will be described in more detail with reference to FIG. 2.

FIG. 2 is a diagram of a configuration of the message server 100 according to the at least one embodiment of FIG. 1.

Referring to FIG. 2, the message server 100 includes a transceiver unit 110, a control unit 120, and a storage unit 130. All or some components of the message server 100, such as the transceiver unit 110, the control unit 120, and the storage unit 130 are implemented by one or more processors and/or application-specific integrated circuits (ASICs).

The transceiver unit 110 has an interface for transmitting and receiving data over the network 500.

The storage unit 130 is a place for storing file information received from the transmitting terminal 300. The storage unit 130 is an internal storage (or a memory device) of the message server 100, or a data storage server located outside the message server 100 and configured to communicate data with the message server 100. In this case, the file information includes at least one of file link information, a file class ID, and a file size.

The control unit 120 serves to control overall operations of the message server 100 including the transceiver unit 110 and the storage unit 130, and also includes a processor and a memory for storing an associated program. In addition, the control unit 120 provides a chatting service between the transmitting terminal 300 and the receiving terminal 400 by transmitting and receiving a message using the transceiver unit 110. In at least one embodiment of the present disclosure, the control unit 120 receives file information through the transceiver unit 110 from the transmitting terminal 300 using the SIP MESSAGE method, transmits the file information to the receiving terminal 400 through the transceiver unit 110 using the SIP MESSAGE method, and transmits the 202 ACCEPTED message to the transmitting terminal 300 through the transceiver unit 110.

When a predetermined time elapses without a response from the receiving terminal 400 due to that the receiving terminal 400 is in an offline state or in a dead zone after the control unit 120 transmits the file information to the receiving terminal 400 using the SIP MESSAGE method, the control unit 120 stores the file information on the corresponding file in the storage unit 130.

In this case, the control unit 120 confirms that there is no response from the receiving terminal 400 at the time of expiration of an internal timer (i.e., preset timer) or by receiving an SIP 480 temporarily-unavailable response indicating that a timer is expired through the transceiver unit 110 from a separate device.

In addition, when the receiving terminal 400 comes back in a communication-enabled state such as in an online state, the control unit 120 receives an SIP REGISTER message for registration from the receiving terminal 400 through the transceiver unit 110, and transmits file information to the receiving terminal 400 through the transceiver unit 110 using the SIP MESSAGE method. The receiving terminal 400 that has received the file information from the control unit 120 uses the file information to request the corresponding file from the content server 200 and downloads the file.

In still at least another embodiment of the present disclosure, when the control unit 120 receives an SIP INVITE message for establishing a session between the transmitting terminal 300 and the receiver terminal 400 from the transmitting terminal 300 through the transceiver unit 110, the control unit 120 transmits the INVITE message to the receiving terminal 400 through the transceiver unit 110, and transmits a 200 OK message as a response to the transmitting terminal 300.

The control unit 120 receives an ACK message from the transmitting terminal 300, and receives file information from the transmitting terminal 300 through the transceiver unit 110 using the MSRP SEND method. When a predetermined time elapses without a response from the receiving terminal 400 due to that the receiving terminal 400 is in an offline state or in a dead zone after the control unit 120 transmits an INVITE message, the control unit 120 stores the file information on the received file in its internal storage or a separate storage. In this case, the control unit 120 confirms that there is no response from the receiving terminal 400 at the time of expiration of an internal timer or by receiving an SIP 480 temporarily-unavailable response indicating that a timer is expired from a separate device. In this case, the file information includes at least one of file link information, a file class ID, and a file size. Afterwards, when the receiving terminal 400 becomes in a communication-enabled state such as in an online state, the control unit 120 receives an SIP REGISTER message from the receiving terminal 400 through the transceiver unit 110, attempts to establish a session with the receiving terminal 400 again, and transmits the file information to the receiving terminal 400 through the transceiver unit 110 using the SIP MESSAGE method.

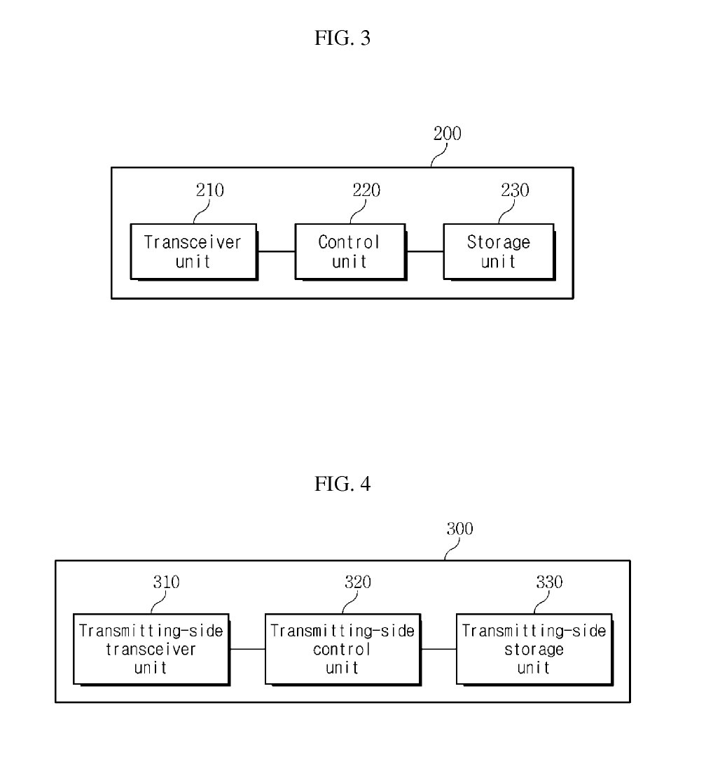

Next, operations and functions of the content server 200 storing and providing files according to the present disclosure will be described in detail with reference to FIG. 3.

FIG. 3 is a diagram of a configuration of the content server 200 according to the at least one exemplary embodiment of FIG. 1.

Referring to FIG. 3, the content server 200 includes a transceiver unit 210, control unit 220, and a storage unit 230. All or some components of the content server 200, such as the transceiver unit 210, the control unit 220, and the storage unit 230 are implemented by one or more processors and/or application-specific integrated circuits (ASICs).

The transceiver unit 210 has an interface for transmitting and receiving data over the network 500.

The storage unit 230 is a place for storing files uploaded from the transmitting terminal 300 and file information on the files. The storage unit 230 of the present disclosure is an internal storage within the content server 200, or a data storage server located outside the content server 200 and configured to transmit and receive data to and from the content server 200. In this case, the file information includes at least one of file link information, a file class ID, and a file size. The control unit 220 serves to control overall operations of the content server 200 including the transceiver unit 210 and the storage unit 230, and also includes a processor and a memory for storing an associated program. In addition, the control unit 220 provides a chatting service between the transmitting terminal 300 and the receiving terminal 400 through message transmission and reception using the transceiver unit 210.

When the control unit 220 receives the files from the transmitting terminal 300 through the transceiver unit 210 in embodiments of the present disclosure, the control unit 220 stores the corresponding files in a user directory or the like of the storage unit 230. In this case, the control unit 220 receives the files uploaded from the transmitting terminal 300 through the HTTP POST message.

The control unit 220 transmits file information on the file stored in the storage unit 230 to the transmitting terminal 300 through the transceiver unit 210. In this case, the control unit 220 adds the file information including, for example, file link information, a file class ID, and a file size to an HTTP 200 OK message and transmit the message to the transmitting terminal 300. In this case, the file link information transmitted by the control unit 220 to the transmitting terminal 300 includes, for example, information on URL or URI on where the corresponding file is stored.

In addition, the control unit 220 receives an HTTP GET message from the receiving terminal 400 through the transceiver unit 210, and transmits a 200 OK message as a response to the receiving terminal 400. The receiving terminal 400 thus downloads the corresponding file from the content server 200.

In this case, for example, the control unit 220 receives the HTTP GET message including URL or URI information on the stored file from the receiving terminal 400, retrieves a file corresponding to the URL or URI information in the storage unit 230, and transmits the file to the receiving terminal 400. Operations and functions of the transmitting terminal 300 uploading files to the message server 100 according to the present disclosure will be described in detail with reference to FIG. 4.

FIG. 4 is a diagram of a configuration of the transmitting terminal 300 according to the at least one exemplary embodiment of FIG. 1.

Referring to FIG. 4, the transmitting terminal 300 includes a transmitting-side transceiver unit 310, a transmitting-side control unit 320, and a transmitting-side storage unit 330. All or some components of the transmitting terminal 300, such as the transmitting-side transceiver unit 310, the transmitting-side control unit 320, and the transmitting-side storage unit 330 are implemented by one or more processors and/or application-specific integrated circuits (ASICs).

The transmitting-side storage unit 330 has an interface for transmitting and receiving data over the network 500.

The transmitting-side storage unit 330 is a place for storing a file uploaded to the content server 200.

The transmitting-side control unit 320 serves to control overall operations of the transmitting terminal 300 including the transmitting-side transceiver unit 310 and the transmitting-side storage unit 330, and also includes a processor and a memory for storing an associated program.

According to the present disclosure, when a user of the transmitting terminal 300 manipulates the transmitting terminal 300 to transfer an internally stored specific file to the receiving terminal 400, the transmitting-side control unit 320 uploads the file stored in the transmitting-side storage unit 330 to the content server 200 through the transmitting-side transceiver unit 310. In this case, the transmitting-side control unit 320 allows the file to be transmitted to the content server 200 using the HTTP POST message.

The transmitting-side control unit 320 that has uploaded the file to the content server 200 receives file information on the corresponding file from the content server 200 through the transmitting-side transceiver unit 310.

In this case, the transmitting-side control unit 320 receives the file information included in a body of a 200 OK message in response to the HTTP POST message transmitted to the content server 200. In this case, the 200 OK message received by the transmitting-side control unit 320 includes, for example, file link information, a file class ID, and a file size.

The transmitting-side control unit 320 transmits the file information received from the content server 200 to the message server 100 through the transmitting-side transceiver unit 310. In this case, the transmitting-side control unit 320 transmits the file information to the message server 100 using the SIP MESSAGE method or the MSRP SEND method.

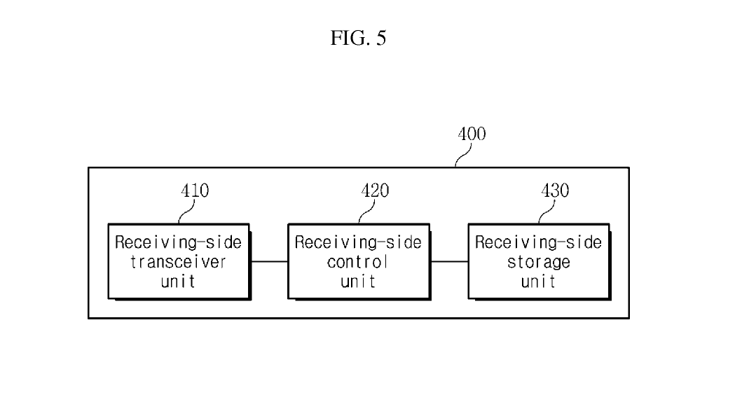

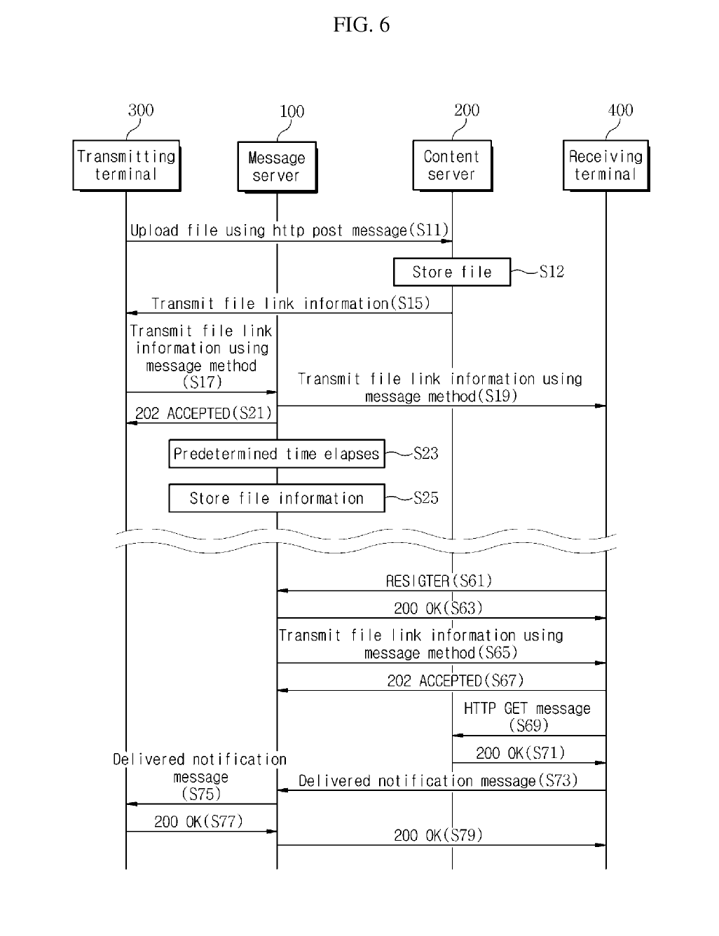

Operations and functions of the receiving terminal 400 downloading the file from the message server 100 according to the present disclosure will be described in detail with reference to FIG. 5.

FIG. 5 is a diagram illustrating a configuration of a receiving terminal 400 according to one or more embodiments described with respect to FIG. 1.

Referring to FIG. 5, the receiving terminal 400 includes a receiving-side transceiver unit 410, a receiving-side control unit 420, and a receiving-side storage unit 430. All or some components of the receiving terminal 400, such as the receiving-side transceiver unit 410, the receiving-side control unit 420 and the receiving-side storage unit 430 are implemented by one or more processors and/or application-specific integrated circuits (ASICs).

The receiving-side transceiver unit 410 has an interface for transmitting and receiving data over the network 500.

The receiving-side storage unit 430 is a place for storing a file downloaded from the content server 200.

The receiving-side control unit 420 serves to control overall operations of the receiving terminal 400 including the receiving-side transceiver unit 410 and the receiving-side storage unit 430, and also includes a processor and a memory for storing an associated program.

According to the present disclosure, when the receiving terminal 400 that has been in a communication-disabled state such as in an offline state or in a dead zone becomes in a communication-enabled state, the receiving-side control unit 420 transmits the SIP REGISTER message to the message server 100 through the receiving-side transceiver unit 410 to request for registration.

The receiving-side control unit 420 receives file information from the message server 100 through the receiving-side transceiver unit 410 using the SIP MESSAGE method.

The receiving-side control unit 420 that has received the file information from the message server 100 uses the file information to request the corresponding file from the control unit 220 of the content server 200, and then downloads and stores the file in the receiving-side storage unit 430. In this case, the receiving-side control unit 420 transmits the HTTP GET message to the content server 200 through the receiving-side transceiver unit 410, receive the 200 OK message as a response, and download the corresponding file.

An example of a process of transmitting a file included in the transmitting terminal 300 to the receiving terminal 400 according to the present disclosure will be described in more detail with reference to FIG. 6.

FIG. 6 is a flowchart illustrating a method of transmitting files to a communication-disabled terminal according to at least one embodiment of the present disclosure.

Referring to FIG. 6, the transmitting terminal 300 uploads an internally stored file to the content server 200 using the HTTP POST message (S11).

The content server 200 stores the file received in step S11 in an internal storage or a separate storage server (S13), and transmits file information on the stored file to the transmitting terminal 300 (S15).

In step S15, for example, the content server 200 adds the file information to a body of the 200 OK message and transmit the message as a response to the HTTP POST message received in step S11 to the transmitting terminal 300.

In step S15, the file information transmitted by the content server 200 includes, for example, at least one of file link information, a file class ID, and a file size. Here, the file link information transmitted by the message server 100 to the transmitting terminal 300 includes information on URL or URI indicating the position of the corresponding file.

The transmitting terminal 300 that has received the file information in step S15 transmits the corresponding file information to the message server 100 using the SIP MESSAGE method (S17), and the message server 100 transmits the file information to the receiving terminal 400 using the SIP MESSAGE method again (S19). In this case, the MESSAGE is an SIP method used to deliver a message to a partner terminal, and is delivered irrespective of session establishment between the transmitting terminal 300 and the receiving terminal 400.

After the message server 100 transmits the file information to the receiving terminal 400 using the SIP MESSAGE method, the message server 100 transmits a 202 ACCEPTED message as a response to the transmitting terminal 300 (S21). Here, the 202 ACCEPTED message is a response code indicating that a request is received but whether to process the request is not determined.

Afterwards, when a predetermined time elapses without a response from the receiving terminal 400 due to that the receiving terminal 400 is in an offline state or in a dead zone (S23), the message server 100 stores the file information on the corresponding file in an internal or separate storage (S25).

In step S23, the message server 100 confirms that there is no response from the receiving terminal 400 at the time of expiration of an internal timer or by receiving an SIP 480 temporarily-unavailable response indicating that a timer is expired from a separate device.

Afterwards, when the receiving terminal 400 becomes in a communication-enabled state such as in an online state, the message server 100 receives an SIP REGISTER message for registration from the receiving terminal 400, and the message server 100 transmits a 200 OK message as a response to the receiving terminal 300 (S63).

The message server 100 transmits the file information to the receiving terminal 300 using the SIP MESSAGE method (S65), and the message server 100 receives the 202 ACCEPTED message as a response from the receiving terminal 300 (S67).

The receiving terminal 300 that has received the file information from the message server 100 in step S65 uses information such as URL or URI of the file link information included in the file information to transmit the HTTP GET message to the content server 200 to request for the file (S69), and receives a 200 OK message as a response and downloads the corresponding file (S71).

The receiving terminal 400 that has downloaded the file transmits a delivered notification message indicating the download to the message server 100 (S73), and the message server 100 transmits the delivered notification message to the transmitting terminal 300 again to notify that the file is downloaded (S75).

The delivered notification message transmitted in step S73 or the delivered notification message transmitted in step S75 is transmitted using the SIP MESSAGE method.

The transmitting terminal 300 that has received the delivered notification message in step S75 transmits a 200 OK message as a response to the message server 100 (S77), and the message server 100 transmits the 200 OK message to the receiving terminal 400 again (S79).

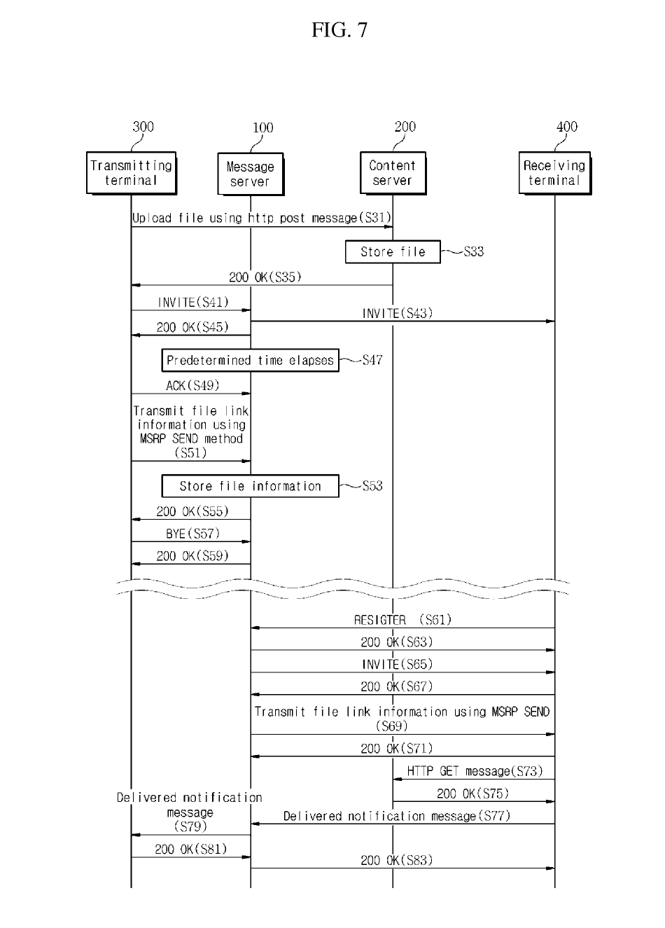

Another example of process of transmitting a file included in the transmitting terminal 300 to the receiving terminal 400 according to the present disclosure will be described in more detail with reference to FIG. 7.

FIG. 7 is a flowchart illustrating a method of transmitting files to a communication-disabled terminal according to at least another embodiment of the present disclosure.

Referring to FIG. 7, the transmitting terminal 300 uploads an internal file to the content server 200 using an HTTP POST message (S31).

The content server 200 stores the file received in step S31 in an internal or separate storage server (S33), and transmits file information on the stored file to the transmitting terminal 300 (S35).

In step S35, for example, the content server 200 adds the file information to a body of a 200 OK message and transmit the message as a response to the HTTP POST message received in step S31 to the transmitting terminal 300.

In this case, the file information includes, for example, at least one of file link information, a file class ID, and a file size. The file link information transmitted by the content server to the transmitting terminal 300 includes information such as URL or URI indicating the position of the corresponding file.

An SIP INVITE message for establishing a session between the transmitting terminal 300 and the receiving terminal 400 is then transmitted from the transmitting terminal 300 to the message server 100 (S41), and the message server 100 transmits the INVITE message to the receiving terminal 400 (S43).

After the message server 100 transmits the INVITE message to the receiving terminal 400 in step S43, the message server 100 transmits the 200 OK message as a response to the transmitting terminal 300 (S45). In this case, a predetermined time elapses without a response from the receiving terminal 400 due to that the receiving terminal 400 is in an offline state or in a dead zone (S47). Here, the message server 100 confirms that there is no response from the receiving terminal 400 at the time of expiration of an internal timer or by receiving an SIP 480 temporarily-unavailable response indicating that a timer is expired from a separate device. The transmitting terminal 300 transmits an ACK message as a response to the message server 100 (S49), and transmits the file information to the message server 100 using an MSRP SEND method (S51). The message server 100 then stores the file information received from the transmitting terminal 300 in an internal or separate storage (S53), and transmits the 200 OK message as a response to the transmitting terminal 300 (S55).

The transmitting terminal 300 terminates the session by transmitting an SIP BYE message to the message server 100 (S57), and the message server 100 responds to it by transmitting the 200 OK message to the transmitting terminal 300 (S59).

Afterwards, when the receiving terminal 400 becomes in a communication-enabled state such as in an online state, the message server 100 receives an SIP REGISTER message for registration from the receiving terminal 400 (S61), and the message server 100 transmits the 200 OK message to the receiving terminal 300 using the 200 OK message (S63).

Since the message server 100 has failed to establish the previous session with the receiving terminal 400, the message server attempts to establish the session again. Accordingly, the message server 100 transmits an INVITE message for establishing the session to the receiving terminal 400 (S65), and receives the 200 OK message as a response to the session establishment from the receiving terminal 400 to complete the session establishment (S67).

Then, the message server 100 transmits file information to the receiving terminal 300 using the MSRP SEND (S69), and the message server 100 receives the 200 OK message as a response from the receiving terminal 300 (S71).

The receiving terminal 400 then downloads the file from the message server 100 through predetermined steps (S73 to S83), which are same as those (S69 to S79) described with reference to FIG. 6 and a detailed description thereof will thus be omitted.

According to various embodiments of the present disclosure, even when a receiving terminal is in a communication-disabled state such as in an offline state or in a dead zone, the above described exemplary embodiments render an effective advantage to upload a file to a server on a network and transmit the corresponding file to the receiving terminal without having to wait for the communication-enabled state of the receiving terminal, which can thus reduce loads generated due to repetitive file transmission attempts, enhance the transmission efficiency, and promote the convenience of Internet service providers and IM service users.

Some embodiments as described above are implemented in the form of one or more program commands that are read and executed by a variety of computer systems and be recorded in any non-transitory, computer-readable recording medium. The non-transitory computer-readable recording medium includes a program command, a data file, a data structure, etc. alone or in combination. The program commands written to the medium are designed or configured especially for the at least one embodiment, or known to those skilled in computer software. Examples of the computer-readable recording medium include magnetic media such as a hard disk, a floppy disk, and a magnetic tape, optical media such as a CD-ROM and a DVD, magneto-optical media such as an optical disk, and a hardware device configured especially to store and execute a program, such as a ROM, a RAM, and a flash memory. Examples of a program command include a premium language code executable by a computer using an interpreter as well as a machine language code made by a compiler. The hardware device is configured to operate as one or more software modules to implement one or more embodiments of the present disclosure. In some embodiments, one or more of the processes or functionality described herein is/are performed by specifically configured hardware (e.g., by one or more application specific integrated circuits or ASIC(s)). Some embodiments incorporate more than one of the described processes in a single ASIC. In some embodiments, one or more of the processes or functionality described herein is/are performed by at least one processor which is programmed for performing such processes or functionality.

While the disclosure has been shown and described with reference to preferred embodiments thereof, it will be understood by those skilled in the art that such description is for illustrative purposes only and various changes and modifications are made without departing from the spirit and scope of the claimed invention as defined by the appended claims. Specific terms used in this disclosure and drawings are used for illustrative purposes and not to be considered as limitations of the present disclosure. Exemplary embodiments of the present disclosure have been described for the sake of brevity and clarity. Therefore, all such changes and modifications, and the equivalents thereof, will be considered to be within the spirit and scope of the claimed invention.

What is claimed is:

1. An apparatus for transmitting a file to a terminal device in a communication-disabled state, the apparatus comprising:
a transceiver unit configured to transmit and receive data;
a storage unit configured to store therein file information on a file uploaded to a content server by a transmitting terminal device using a first protocol; and
a control unit configured to
receive the file information from the transmitting terminal device through the transceiver unit using a second protocol,
deliver the received file information to a receiving terminal device using the second protocol,
store the file information in the storage unit when a predetermined time elapses without a response from the receiving terminal device, and
transmit the stored file information to the receiving terminal device through the transceiver unit when the receiving terminal device enters into a communication-enabled state.

2. The apparatus of claim 1, wherein the first protocol is hypertext transfer protocol (HTTP), and
the second protocol is a session initiation protocol (SIP) or a message session relay protocol (MSRP).

3. The apparatus of claim 2, wherein the control unit is configured to use an SIP MESSAGE method or an MSRP SEND method when the control unit receives the file information from the transmitting terminal device and deliver the received file information to the receiving terminal device.

4. The apparatus of claim 1, wherein the file information includes at least one of file link information, a file ID, and a file size.

5. An apparatus for transmitting a file to a terminal device in a communication-disabled state, the apparatus comprising:
a transceiver unit configured to transmit and receive data;
a storage unit configured to store therein file information on a file uploaded to a content server by a transmitting terminal device; and
a control unit configured to
store the received file information in the storage unit when receiving the file information using a message session relay protocol (MSRP) SEND method from the transmitting terminal device through the transceiver unit after a predetermined time elapses without a response from a receiving terminal device even though session establishment is attempted between the transmitting terminal device and the receiving terminal device, and
transmit the stored file information to the receiving terminal device through the transceiver unit when the receiving terminal device enters into a communication-enabled state.

6. The apparatus of claim 5, wherein the control unit is configured to
attempt session establishment of a session initiation protocol (SIP) between the transmitting terminal device and the receiving terminal device when the transmitting terminal device requests the session establishment, and
transmit a 200 OK message of the session initiation protocol (SIP) to the transmitting terminal device in response to the request of the session establishment.

7. The apparatus of claim 5, wherein the control unit is further configured to confirm that there is no response from the receiving terminal device at the time of expiration of an internal timer or by receiving through the transceiver unit an SIP 480 temporarily-unavailable response indicating that a timer is expired.

8. The apparatus of claim 5, wherein the control unit is further configured to store in the storage unit the file information on at least one of file link information, a file ID, and a file size.

9. The apparatus of claim 5, wherein the control unit is further configured to transmit the file information to the receiving terminal device through the transceiver unit using an SIP MESSAGE method of a session initiation protocol (SIP) when receiving an SIP REGISTER message of the session initiation protocol (SIP) through the transceiver unit from the receiving terminal device which enter into in the communication-enabled state back from the communication-disabled state.

10. A non-transitory computer readable recording medium containing a program, the program, when executed by a message server, causing the message server to execute:
receiving, from a transmitting terminal device, file information on a file uploaded to a content server, wherein the file is uploaded by the transmitting terminal device using a first protocol;
attempting to contact a receiving terminal device using a second protocol;
determining that the receiving terminal device is in a communication-disabled state and storing the file information; and
transmitting the stored file information to the receiving terminal device when the receiving terminal device enters into a communication-enabled state back from the communication-disable state such that the receiving terminal device downloads the uploaded file through the first protocol from the content server by using the file information.

11. The non-transitory computer-readable recording medium of claim 10, wherein the first protocol is hypertext transfer protocol (HTTP), and
the second protocol is a session initiation protocol (SIP) or a message session relay protocol (MSRP).

12. The non-transitory computer-readable recording medium of claim 10, wherein the program, when executed by the message server, further causes the message server to execute:
attempting session establishment between the transmitting terminal device and the receiving terminal device when the transmitting terminal device requests the session establishment; and
transmit a 200 OK message of the session initiation protocol (SIP) to the transmitting terminal device in response to the request of the session establishment.

13. The non-transitory computer-readable recording medium of claim 10, wherein the response message is an 202 ACCEPTED message of the second protocol.
